(19) United States
(12) Patent Application Publication
(10) Pub. No.: US 2001/0047401 A1
(43) Pub. Date: Nov. 29, 2001

(54) System and method for managing connections to servers delivering multimedia content

(76) Inventors: Brennan J. McTernan, Fanwood, NJ (US); Adam Nemitoff, Ridgewood, NJ (US); Altay Murat, Richmond Hill, NY (US); Vishal Bangia, Jersey City, NJ (US)

Correspondence Address: Brown Raysman Millstein, Felder & Steiner LLP, 900 3rd Ave., New York, NY, 10022-4728, US

(21) Appl. No.: 09/767,602

(22) Filed: Jan. 22, 2001

Related U.S. Application Data
(60) Provisional application No. 60/177,397, filed on Jan. 21, 2000.
(60) Provisional application No. 60/177,394, filed on Jan. 21, 2000.
(60) Provisional application No. 60/177,396, filed on Jan. 21, 2000.
(60) Provisional application No. 60/177,395, filed on Jan. 21, 2000.
(60) Provisional application No. 60/177,398, filed on Jan. 21, 2000.
(60) Provisional application No. 60/177,399, filed on Jan. 21, 2000.
(60) Provisional application No. 60/182,434, filed on Feb. 15, 2000.
(60) Provisional application No. 60/204,386, filed on May 15, 2000.

(51) Int. Cl. G06F 15/16

(52) U.S. Cl. 709/219; 709/231

(57) ABSTRACT

A method and software for managing the process for establishing a connection to a server over a network for the delivery of multimedia content. For a selected item of content, the software downloads a list of available servers which can provide the content, with the list including servers of different types which transmit data in different ways. Examples of different types of servers include servers which support multicasting, servers which support UDP transmissions, and servers which support TCP transmissions. The software traverses the guide and sequentially attempts to establish connections to the servers in the guide, until either a connection is established or all servers in the guide have been tried.

Applicant(s) hereby claims the benefit of the following provisional patent applications:

provisional patent application Ser. No. 60/177,397, titled “VIRTUAL SET ON THE INTERNET,” filed Jan. 21, 2000, attorney docket no. 38903-007;

provisional patent application Ser. No. 60/177,394, titled “MEDIA ENGINE,” filed Jan. 21, 2000, attorney docket no. 38903-004;

provisional patent application Ser. No. 60/177,396, titled “TAP METHOD OF ENCODING AND DECODING INTERNET TRANSMISSIONS,” filed Jan. 21, 2000, attorney docket no. 38903-006;

provisional patent application Ser. No. 60/177,395, titled “SCALABILITY OF A MEDIA ENGINE,” filed Jan. 21, 2000, attorney docket no. 38903-005;

provisional patent application Ser. No. 60/177,398, titled “CONNECTION MANAGEMENT,” filed Jan. 21, 2000, attorney docket no. 38903-008;

provisional patent application Ser. No. 60/177,399, titled “LOOPING DATA RETRIEVAL MECHANISM,” filed Jan. 21, 2000, attorney docket no. 38903-009;

provisional patent application Ser. No. 60/182,434, titled “MOTION CAPTURE ACROSS THE INTERNET,” filed Feb. 15, 2000, attorney docket no. 38903-010; and

provisional patent application Ser. No. 60/204,386, titled “AUTOMATIC IPSEC TUNNEL ADMINISTRATION,” filed May 10, 2000, attorney docket no. 38903-014.

Each of the above listed applications is incorporated by reference herein in its entirety.

### RELATED APPLICATIONS

This application is related to the following commonly owned patent applications, filed concurrently herewith, each of which applications is hereby incorporated by reference herein in its entirety:

application Ser. No. ______, titled “METHOD AND SYSTEM FOR DISTRIBUTING VIDEO USING A VIRTUAL SET,” attorney docket no. 4700/2;

application Ser. No. ______, titled “SYSTEM AND METHOD FOR ACCOUNTING FOR VARIATIONS IN CLIENT CAPABILITIES IN THE DISTRIBUTION OF A MEDIA PRESENTATION,” attorney docket no. 4700/4;

application Ser. No. ______, titled “SYSTEM AND METHOD FOR USING BENCHMARKING TO ACCOUNT FOR VARIATIONS IN CLIENT CAPABILITIES IN THE DISTRIBUTION OF A MEDIA PRESENTATION,” attorney docket no. 4700/5; and

application Ser. No. ______, titled “SYSTEM AND METHOD FOR RECEIVING PACKET DATA MULTICAST IN SEQUENTIAL LOOPING FASHION,” attorney docket no. 4700/7.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to techniques for distributing interactive multimedia content across computer networks. More particularly, the present invention relates to an improved system and method for efficiently dividing processing between servers distributing content and clients playing back the received content, thereby allowing a richer interactive experience and maximizing processing power of both clients and servers.

Over the past decade, processing power available to both producers and consumers of multimedia content has increased exponentially. Approximately a decade ago, the transient and persistent memory available to personal computers was measured in kilobytes (8 bits=1 byte, 1024 bytes=1 kilobyte) and processing speed was typically in the range of 2 to 16 megahertz. Due to the high cost of personal computers, many institutions opted to utilize “dumb” terminals, which lack all but the most rudimentary processing power, connected to large and prohibitively expensive mainframe computers that “simultaneously” distributed the use of their processing cycles with multiple clients.

Today, transient and persistent memory is typically measured in megabytes and gigabytes, respectively (1,048,576 bytes=1 megabyte, 1,073,741,824 bytes=1 gigabyte). Processor speeds have similarly increased, modem processors based on the x86 instruction set are available at speeds up to 1.5 gigahertz (approximately 1000 megahertz=1 gigahertz). Indeed, processing and storage capacity have increased to the point where personal computers, configured with minimal hardware and software modifications, fulfill roles such as data warehousing, serving, and transformation, tasks that in the past were typically reserved for mainframe computers. Perhaps most importantly, as the power of personal computers has increased, the average cost of ownership has fallen dramatically, providing significant computing power to average consumers.

The past decade has also seen the widespread proliferation of computer networks. With the development of the Internet in the late 1960's followed by a series of inventions in the fields of networking hardware and software, the foundation was set for the rise of networked and distributed computing. Once personal computing power advanced to the point where relatively high speed data communication became available from the desktop, a domino effect was set in motion whereby consumers demanded increased network services, which in turn spurred the need for more powerful personal computing devices. This also stimulated the industry for Internet Service providers or ISPs, which provide network services to consumers.

Computer networks transfer data according to a variety of protocols, such as UDP (User Datagram Protocol) and TCP (Transport Control Protocol). According to the UDP protocol, the sending computer collects data into an array of memory referred to as a packet. IP address and port information is added to the head of the packet. The address is a numeric identifier that uniquely identifies a computer that is the intended recipient of the packet. A port is a numeric identifier that uniquely identifies a communications connection on the recipient device.

Once the data packet is addressed, it is transmitted from the sending device across a network via a hardware network adapter, where intermediary computers (e.g., routers) relay the packet to the appropriate port on the device with the appropriate unique IP address. When data is transmitted according to the UDP protocol, however, no attempt is made to inform the sender that the data has successfully arrived at the destination device. Moreover, there is neither feedback from the recipient regarding the quality of the transmission nor any guarantee that subsequent data sent out sequentially by the transmitting device will be received in the same sequence by the recipient.

According to the Transmission Control Protocol, or TCP, data is sent using UDP packets, but there is an underlying “handshake” between sender and recipient that ensures a suitable communications connection is available. Furthermore, additional data is added to each packet identifying its order in an overall transmission. After each packet is received, the receiving device transmits acknowledgment of the receipt to the sending device. This allows the sender to verify that each byte of data sent has been received, in the order it was sent, to the receiving device. Both the UDP and TCP protocols have their uses. For most purposes, the use of one protocol over the other is determined by the temporal nature of the data. Data can be viewed as being divided into two types, transient or persistent, based on the amount of time that the data is useful.

Transient data is data that is useful for relatively short periods of time. For example, a television transmits a video signal consisting of 30 frames of imagery each second. Thus, each frame is useful for 1/30^{th} of a second. For most applications, the loss of one frame would not diminish the utility of the overall stream of images. Persistent data, by contrast, is useful for much longer periods of time and must typically be transmitted completely and without errors. For example, a downloaded record of a bank transaction is a permanent change in the status of the account and is necessary to compute the overall account balance. Loosing a bank transaction or receiving a record of a transaction containing errors would have harmful side effects, such as inaccurately calculating the total balance of the account.

UDP is useful for the transmission of transient data, where the sender does not need to be delayed verifying the receipt of each packet of data. In the above example, a television broadcaster would incur an enormous amount of overhead if it was required to verify that each frame of video transmitted has been successfully received by each of the millions of televisions tuned into the signal. Indeed, it is inconsequential to the individual television viewer that one or even a handful of frames have been dropped out of an entire transmission. TCP, conversely, is useful for the transmission of persistent data where the failure to receive every packet transmitted is of great consequence.

One of the reasons that the Internet is a successful medium for transmitting data is because the storage of information regarding identity and location of devices connected to it is decentralized. Knowledge regarding where a device resides on a particular part of the network is distributed over a plurality of sources across the world. A connection between to remotely located devices can traverse a variety of paths such that if one path becomes unavailable, another route is utilized.

Each network on the Internet is uniquely identified with a numeric address. Each device within a network, in turn, is identified by an IP address that is comprised of a subnet address coupled with a unique device ID. According to version four of this standard (“IPv4”) an IP address is a 32-bit number that is represented by four “dot” separated values in the range from 0 through 255, e.g., 123.32.65.72. Each device is further configured with a subnet mask. The mask determines which bits of a device's IP address represent the subnet and which represent the device's ID. For example, a device with an IP address of 123.32.65.72 and a subnet mask of 255.255.255.0 has a subnet address of 123.32.65 and an ID of 72.

Each packet of data sent by a device, whether it is formatted according to the UDP or TCP protocols, has a header data field. The header is an array of bytes at the beginning of a packet that describe the data's destination, its origin, its size, etc. When a sender and recipient are both located within the same subnet, the recipient device's network hardware examines network traffic for packets tagged with its address. When a packet addressed to the recipient is identified, the network hardware will pass the received data off to the operating system's network services software for processing.

When a sender and recipient are located in different subnets, data is relayed from the originating subnet to the destination subnet primarily through the use of routers. While other physical transport methodologies are available, e.g., circuit switched transmission systems such as ATM (Asynchronous Transfer Mode), the majority of computer networks utilize packet switched hardware such as routers. A router is a device that interconnects two networks and contains multiple network hardware connections. Each network connection is associated with, and provides a connection to, a distinct subnet.

Two tasks are performed when a packet, destined for a subnet that is different from the subnet it is currently in, reaches a router within the current subnet. First, the router examines the subnets that it is connected to via its network hardware. If the router is connected to the packet's destination subnet, it forwards the packet to the router in the appropriate subnet. If the router is not directly connected to the packet's destination subnet, it queries other routers available on its existing connections to determine if any of them are directly connected to the destination subnet. When a router directly connected to the destination subnet is discovered, the packet is forwarded to it. Where a router connected to the destination subnet is not found, however, the router propagates the packet to a top level router that is strategically placed to allow access, either directly or through other top level routers, to the entire Internet. These top level routers are currently maintained by a registration authority under government oversight.

The transmission method described above is referred to as the unicast method of transmission, whereby a sender establishes a unique connection with each recipient. By utilizing a unicast model, the specific address of the receiving machine is placed in the packet header. Routers detect this address and forward the packet so that it ultimately reaches its intended recipient. This method, however, is not the most efficient means for distributing information simultaneously to multiple recipients. The transmission method that best facilitates broadcasting to many recipients simultaneously is multicasting.

Multicasting relies on the use of specialized routers referred to as multicast routers. These routers look only for data packets addressed to devices in the range of 224.0.0.0 through 239.255.255.255. This address range is specifically set aside for the purpose of facilitating multicast transmissions. Multicast routers retain an index of devices that wish to receive packets addressed to ports in this address range. Recipients wishing to receive multicast packets “subscribe” to a specific IP address and port within the multicast address space. The multicast routers respond to the subscription request and proceed to forward packets destined to the particular multicast address to clients who have subscribed to receive them.

Under the multicast model, the sender transmits packets to a single address, as opposed to the unicast model where the data is transmitted individually to each subscribing recipient. The multicast routers handle replication and distribution of packets to each subscribing client. The multicast model, like the broadcast model, can be conceptually viewed as a “one-to-many” connection and, therefore, must use the UDP protocol. UDP must be utilized because the TCP protocol requires a dialog between the sender and receiver that is not present in a multicast environment.

As previously described, Internet Service Providers or ISPs, provide connections between local networks and the Internet. A router is used to connect the customer's local network to the ISP and forwards data packets not addressed to devices within the local network to the ISP for relay across the Internet to the packet's intended recipient. There are no regulations, however, regarding the types of routers supported by ISPs and many of them do not incur the cost of providing and maintaining multicast routers. Because of this limitation, not all systems can subscribe to multicast addresses.

Many ISPs restrict the transmission of UDP packets across their networks. Since these packets do not require a persistent link between sender and receiver, they are referred to as anonymous packets. Security issues involved with this anonymity is the reason for restrictions on the transmission of these packets, which has the twofold effect of restricting the use of UDP packets and preventing users from subscribing to multicast services.

There is thus a need for a system and method that allows users to subscribe and receive multicast transmissions, even when these transmissions are not supported by a users ISP. Strategies are required for allowing a user to receive multicast transmissions regardless of whether the client's connection supports, multicast, unicast UDP, or unicast TCP.

### BRIEF SUMMARY OF THE INVENTION

It is an object of the present invention to solve the problems described above relating to existing content delivery systems.

It is another object of the present invention to provide clients the ability to select the best connection available to them for the delivery of content.

It is another object of the present invention to more effectively manage the process of connecting to servers over the Internet.

The above and other objects are achieved by a software component running on a client computer connected to a network such as the Internet which manages the connection of the client to a server to receive the delivery of content. When a client requests an item of multimedia content, such as a program, movie, or other video or audio file, the connection manager software retrieves a server guide over the Internet from a guide server. The server guide lists the servers, e.g., by server address and server type, from which the content may be retrieved. In some embodiments, the guide server stores a number of different server guides representing different locations at which the content may be accessed, and selects one of the server guides based on load balancing, resource allocation, or other concerns.

The server guide lists servers using different mechanisms or types of transmissions. Such types include servers configured to multicast content, servers configured to receive a multicast transmission and package the data for unicast transmission using, e.g., UDP, and servers configured to receive a multicast transmission and package data for TCP transmission. Preferably, the server guide lists the servers in a desired connection sequence, such as multicast router, multicast-in unicast-out proxy, and then multicast-in unicast-TCP-out proxy.

The above and other objects are also achieved by a method for managing a retrieval of multimedia content over a computerized network, the network having a plurality of servers connectable to one or more clients. The method involves retrieving at a first client a server guide identifying a list of servers capable of delivering a selected item of multimedia content and the first client automatically determining whether a connection may be made to a first server identified in the server guide to achieve delivery of the selected content item. If the connection may be made, the first client establishes a connection with the first server to retrieve the selected content item therefrom. If the connection is unable to be made, the first client automatically determines whether a connection may be made to a second server identified in the server guide to achieve delivery of the selected content item. The first client repeats these steps for the second server and any additional server(s) identified in the server guide until a connection may be made to a server by which the selected content item may be delivered.

The servers identified in the server guide may include one or more routers connectable to a content server, the content server storing the selected content item. In some embodiments, the first server is a multicast router and the second server is a multicast-in unicast-out proxy configured to receive data from the multicast router and provide a unicast connection to the first client such as via UDP. In addition, the server guide may identify as a third server a multicast-in unicast-TCP-out proxy configured to receive requests for parts of the content item from clients, subscribe to the multicast router or multicast-in unicast-out proxy router, and deliver to clients data packets via, e.g., TCP, representing requested parts of the content item. The steps of automatically determining whether a connection may be made are preferably performed first for the multicast router, then for the multicast-in unicast-out proxy router, and then for the multicast UDP router, but may be performed in any given sequence provided in the server guide.

Some of the above and other objects of the present invention are also achieved by a system for establishing a connection over a network to retrieve multimedia content. The system contains a memory device storing a server guide identifying a list of servers capable of delivering a selected item of multimedia content, the list including servers differing in transmission techniques. The server guide may have been downloaded from a server which provides such guides. The system further contains a connection manager for automatically attempting to establish a connection to the servers contained in the list one at a time and, upon determining that a connection can not be established for a given server, attempting to establish a connection to another server in the list until a connection is established or connections can not be established to all servers.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting the hardware and software components according to one embodiment of the present invention;

FIG. 2 is a flow diagram presenting an overview of the connection management process according to one embodiment of the present invention;

FIG. 3 is a flow diagram presenting the process of connection management using various proxy servers, according to one embodiment of the present invention;

FIG. 4 is a block diagram presenting a multicast client connecting to a server via a network, according to one embodiment of the present invention;

FIG. 5 is a block diagram presenting a non-multicast enabled client connecting to a server via a network, according to one embodiment of the present invention; and

FIG. 6 is a block diagram presenting a client capable of initiating only TCP connections connecting to a server via a network, according to one embodiment of the present invention.

### DETAILED DESCRIPTION OF THE PREFERRED EMBODIMENTS

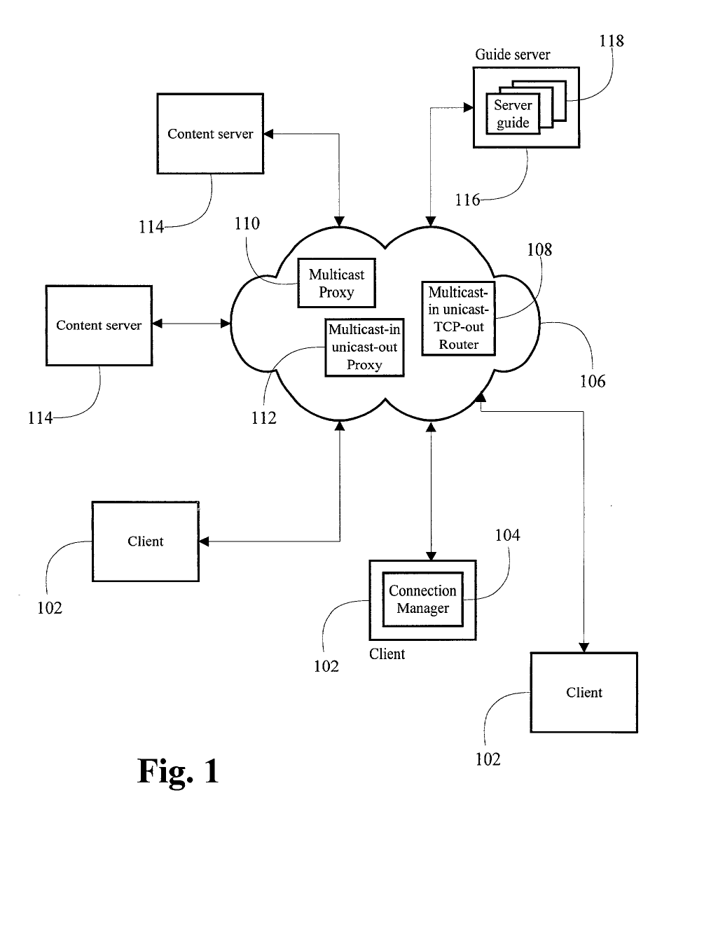

Preferred embodiments of the present invention are now described with reference to the drawings in the figures. With reference to FIG. 1, one configuration of a system in accordance with the present invention includes various hardware and software components, including client devices 102 each containing a software component referred to herein as a Connection Manager 104. Users access content through the use of client devices 102. Client devices 102 may be any general purpose computing devices with the capacity to access a data network 106 including, but not limited to, personal computers, wireless computing devices, personal digital assistants. The data network may be any type of computerized network capable of carrying data, such as the Internet, intranets, LANs, WANs, etc.

Client device 102 contains and executes the Connection Manager 104 in order to negotiate and maintain a connection with content servers 114, which provide content used in delivering a presentation or show. The Connection Manager 104 executes routines on the client 102 when an attempt is made to establish the connection. As explained more fully below, the routines include directing the client 102 to establish a multicast, unicast UDP, or unicast TCP connection based upon the requirements of the network provider that the client device 102 is using to connect to the data network 106. The connection manager software 104 further determines appropriate bandwidth and ensures that resources are being received appropriately. These functions are described further in the above referenced provisional applications and in commonly owned patent application Ser. No. ______, titled “SYSTEM AND METHOD FOR ACCOUNTING FOR VARIATIONS IN CLIENT CAPABILITIES IN THE DISTRIBUTION OF A MEDIA PRESENTATION,” all of which have been incorporated by reference herein.

When a client 102 requests the transmission of content, a connection is first established with a Guide Server 116. The Guide Server 116 parses the client request and returns an appropriate Server Guide 118 based on the request. The Server Guide comprises a listing of all Content Servers 114 connected to the network 106 that are capable of transmitting the content requested by the client 102 via its Connection Manager 104. The client 102 receives the Server Guide 118 and attempts to initiate a connection with the first content server entry in the guide 118.

The Connection Manager software 104 opens up packet based Internet connections between a server and the client based on the server address and port number listed in the Server Guide 118.

When a connection between the Client 102 and a Server 114 is accomplished, a Table of Contents is downloaded by the Client. The Table of Contents is a list of the resources that will allow the Client to display the show content. The Client uses this Table of Contents to determine what content it needs. Each resource has an associated Channel number. This Channel number is an abstraction of a Server connection and allows the Client to receive this data without having to know about the nature of the connection. The proprietary channel number conceals the details of whether the connection is via Multicast, Unicast UDP or Unicast TCP/IP from the client.

The client 102 will first attempt to make a multicast connection with the Content Server 114 by subscribing to a multicast router 108 that the Content Server 114 is transmitting content through. If the client 102 is incapable of initiating a direct connection with the multicast router 108, due to any number of limitations imposed by the client's network service provider, a connection will be attempted via a Multicast-in unicast-out proxy 110 that emulates the multicast feed but provides a unicast UDP connection. For example, the AOL online service does not currently support or allow for multicast connections. Where the client 102 is connected to a network 106 that is incapable of receiving both multicast and unicast UDP packets, the client 102 will connect to the content server 114 by way of a Multicast-in unicast-TCP-out proxy 112 that responds to TCP based requests for data.

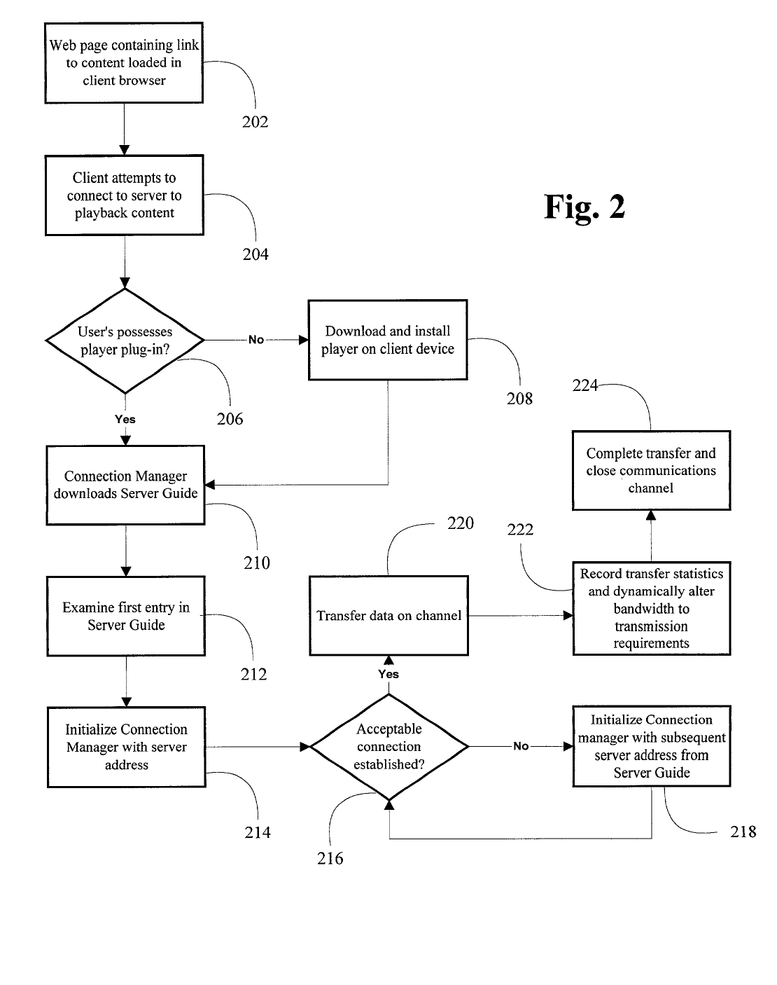

Turning to FIG. 2, a user navigating the World Wide Web (“WWW” or “the Web”) or other interactive content delivery system browses pages containing links to content. For example, a user navigates to a page containing links to the desired content, which is loaded and viewed using a web browser or other viewer capable of rendering pages encoded in Hypertext Markup Language (HTML) 202. Other navigation and rendering systems are also contemplated by the invention, such as systems based on Gopher or that server pages encoded using alternative markup languages.

Independent of the navigation and rendering system used, the user selects a link to the desired content for playback on the client device 204. A check is performed on the client device to determine whether the client has an appropriate plug-in or other software add-on that provides functionality to play back the selected content 206. If the necessary plug-in is not present on the client device, it will be retrieved from an available location 208. Preferably, the link selected by the user to retrieve the content contains parameters that instruct the client as to the location of a server containing the necessary plug-in. Alternatively, supplemental links can be provided linking the page containing the link to the content to a server hosting the plug-in required to playback the selected content.

The client determines that the required plug-in is present on the client device and the Connection Manager initiates a connection with and downloads a Server Guide from the Guide Server 210. Parameters are provided within the link to the selected content instructing the client where the Guide Server for the selected content is located. Alternatively, a plurality of Guide Servers may be provided to the client whereby the client determines the appropriate Guide Server to initiate a connection with. Furthermore, there is no limitation preventing the Guide Server from being the same server hosting the selected content, e.g., the Content Server. The Server Guide is transmitted from the Guide Server to the client using standard HTTP (Hypertext Transmission Protocol) techniques well known to those skilled in the art or any other suitable data transmission techniques.

The client receives the Server Guide transmitted from the Guide Server via a network and examines the Guide's first entry 212. In one embodiment, the Server Guide is a listing of all Content Servers on the network capable of serving the content selected by the user. The Content Servers are preferably listed in order of priority of connection. Alternatively, the Guide Server may store a number of Server Guides, each listing different Content Servers, or listing the same Content Servers in different orders. This alternative allows the Guide Server to select one of the Server Guides based on the current use of resources across all Content Servers, in order to effectuate load balancing.

The Connection Manager is initialized with the address of the supplied server at the top of the Server Guide 214. A connection attempt is initiated between the client and the server whereby the Connection Manager tries to establish an acceptable connection with the server 216. When a connection is established between the client and the server, the client downloads a Table of Contents. The Table of Contents lists the resources needed to view the content being delivered and channels associated with these resources. The client can then download any missing resources via an appropriate channel. The server sends and received packets to and from the channel it is associated with and maintains statistics, such as numbers of bytes received, number of packets dropped, etc. It also actively monitors and alters bandwidth dynamically. If the client fails to acquire a connection with the Content Server 216, the Connection Manager is initialized with a subsequent server address from the Server Guide 218 at which point the Connection Manager once again attempts to initiate a connection with the subsequent server.

Once an acceptable connection is acquired, data is transmitted between the client and Content Server over the communication channel 220. Using techniques described in the above identified provisional applications and application Ser. No. ______ titled “SYSTEM AND METHOD FOR USING BENCHMARKING TO ACCOUNT FOR VARIATIONS IN CLIENT CAPABILITIES IN THE DISTRIBUTION OF A MEDIA PRESENTATION,” the Connection Manager records data transfer statistics and dynamically alters bandwidth to conform to the transmission requirements of the content for the duration of the transmission 222. When the transmission is complete, the communication channel is closed and the routine ends 224.

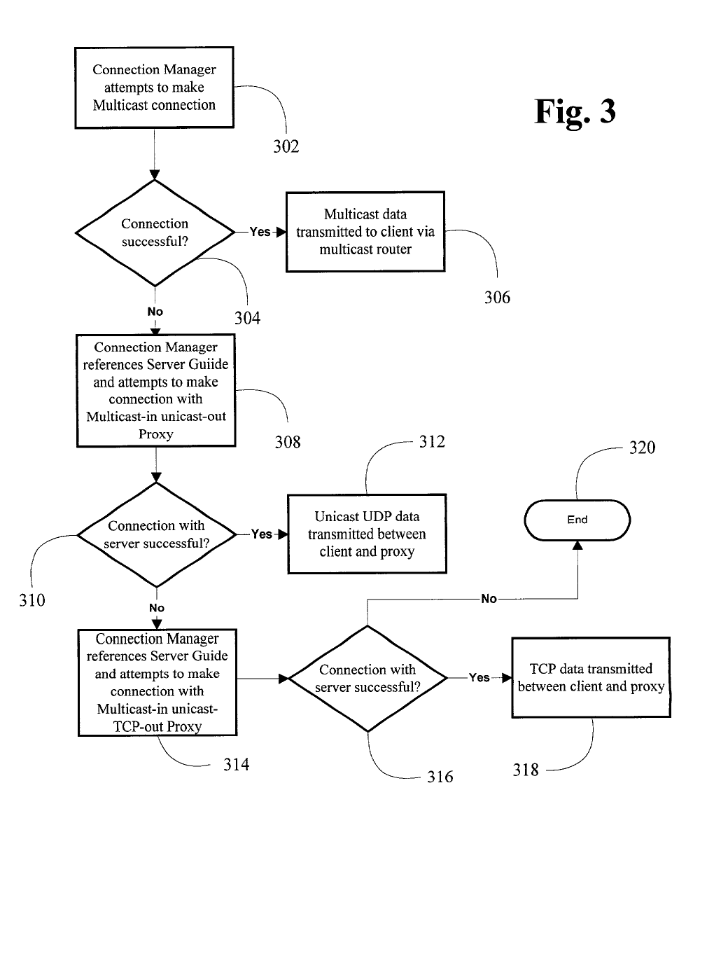

FIG. 3 presents the process involved in initiating and acquiring a connection with a Content Server. The Connection Manager attempts to initiate a connection with the selected Content Server by subscribing to the multicast address which on which data is broadcast from the Content Server, step 302. Multicast is a method for broadcasting data simultaneously to multiple clients across a computer network without maintaining a connection with each client. A check is made to determine if the client successfully subscribed to the multicast address and was able to receive data, step 304. Where the connection is successful, the client will continue to receive multicast data transmitted from the Content Server for the duration of the transmission, step 306.

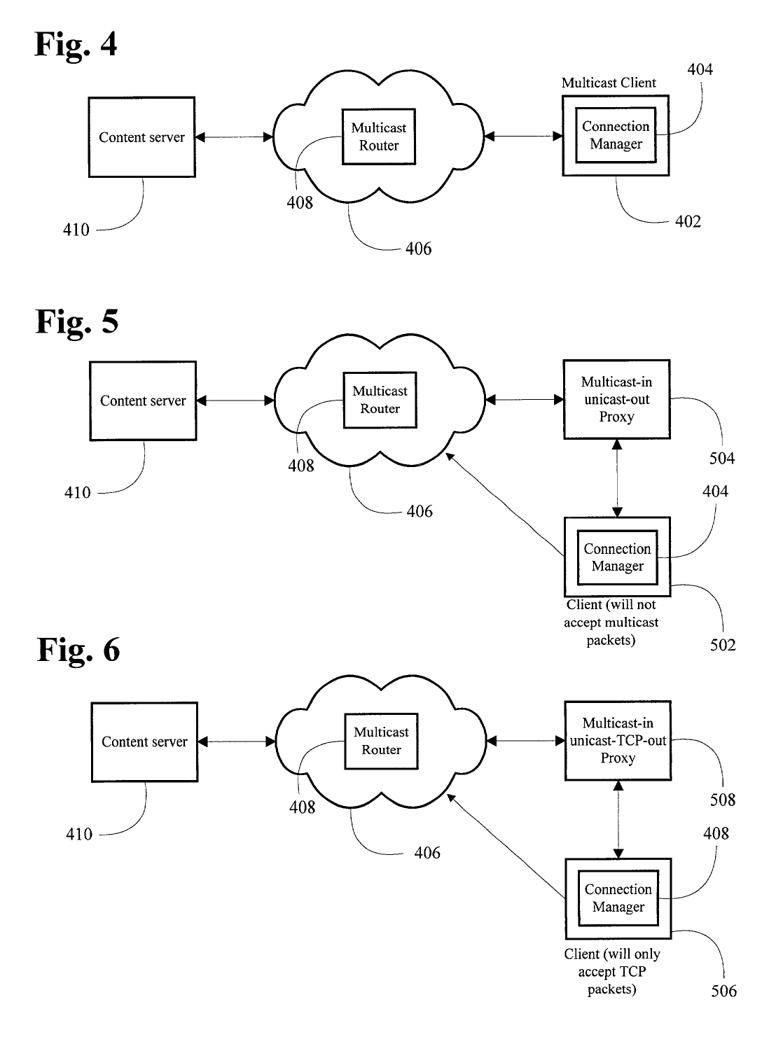

FIG. 4 presents a block diagram of a client connecting to a Content Server via a multicast router, as described in the preceding paragraph. A multicast client 402 contains and executes Connection Management software 404. The Connection Management software subscribes to a multicast address 408 over network 406 to receive multicast transmissions from content server 410.

Turning back to FIG. 3, if the Connection Manager fails to initiate a connection with a multicast router broadcasting the selected content data, step 304, the Connection Manager references the Server Guide and attempt to initiate a connection with the Content Server via a Multicast-in unicast-out proxy 308. A Multicast-in unicast-out proxy is a server that can directly receive a multicast feed while in turn providing a unicast connection with the client. The proxy essentially emulates the multicast router by forwarding the multicast packets over a unicast connection. Each unicast client makes a connection with the Content Server via the multicast-in unicast-out proxy, which is connected via the multicast router. If the client succeeds in making a connection with the Content Server, step 310, unicast UDP data continues to be transmitted to the client via the proxy, step 312.

Referring to FIG. 5, a client is provided that is incapable of receiving multicast packets 502. The client, through the use of its Connection Management software 404, attempts to make a connection with the multicast address 408 via a data network 406 to receive content from the Content Server 410. When the connection attempt fails, the Connection Manager 404 attempts to access the content via a Multicast-in unicast-out proxy 504. A unicast UDP connection is initiated with the proxy 504, which receives data packets retransmitted by the Multicast Router and forwards them to the client across the unicast connection. This allows the unicast UDP client to receive the transmitted multicast content.

Turning once again to FIG. 3, a client that fails to make a connection via a Multicast-in unicast-out proxy, step 310, references the Server Guide and attempts to make a connection by accessing a Multicast-in unicast-TCP-out proxy, step 314. A Multicast-in unicast-TCP-out proxy Server is a system that responds to TCP based requests for data. Requests generated by the client are posted to the Multicast-in unicast-TCP-out proxy. The Proxy, in turn, maintains a subscription with the multicast router broadcasting the selected content. Packets broadcast by the Content Server to the Multicast Router are received by the Proxy and passed on the client as TCP packets across the unicast TCP connection. If the Connection Manager fails to achieve a connection, step 316, the subroutine ends, step 320.

FIG. 6 presents a configuration of the present invention utilizing a Multicast-in unicast-TCP-out proxy as described in the preceding paragraph. As presented in the previous illustrations, a content server 410 transmits content data to a multicast address 408 to subscribing clients. The client 506 in this situation, unable to receive both multicast and UDP data packets for one of any number of reasons, can only accept TCP packets across a unicast connection. The client 506 initiates a connection with a Multicast-in unicast-TCP-out proxy 508. The Multicast-in unicast-TCP-out proxy 508 receives data broadcast by the multicast router 408. The Multicast-in unicast-TCP-out proxy forwards the received UDP packets as TCP packets across its unicast connection with the client 506.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A computer implemented method for managing a retrieval of multimedia content over a computerized network, the network having a plurality of servers connectable to one or more clients, the method comprising:
(a) retrieving at a first client a server guide identifying a list of servers capable of delivering a selected item of multimedia content;
(b) the first client automatically determining whether a connection may be made to a first server identified in the server guide to achieve delivery of the selected content item;
(c) if the connection may be made, the first client establishing a connection with the first server to retrieve the selected content item therefrom;
(d) if the connection is unable to be made, the first client automatically determining whether a connection may be made to a second server identified in the server guide to achieve delivery of the selected content item; and
the first client repeating steps (c) and (d) for the second server and any additional server identified in the server guide until a connection may be made to a server by which the selected content item may be delivered.

2. The method of claim 1, comprising selecting the multimedia content item from a list of available items.

3. The method of claim 1, wherein retrieving the server guide comprises retrieving the guide from a guide server, and comprising the guide server storing a plurality of server guides for the content item and selecting one of the stored server guides upon receipt of a request from the client.

4. The method of claim 1, wherein the servers identified in the server guide include one or more routers connectable to a content server, the content server storing the selected content item.

5. The method of claim 4, wherein the first server is a multicast router and the second server is a multicast-in unicast-out proxy configured to receive data from the multicast router and provide a unicast connection to the first client.

6. The method of claim 5, wherein a third server identified in the server guide is a multicast-in unicast-TCP-out proxy configured to receive requests for parts of the content item from clients, subscribe to the multicast router, and deliver to clients data packets representing requested parts of the content item.

7. The method of claim 6, wherein the steps of automatically determining whether a connection may be made are performed first for the multicast address, then for the multicast-in unicast-out proxy router, and then for the multicast-in unicast-TCP-out proxy.

8. The method of claim 1, wherein the server guide lists the servers in a given sequence, and wherein the steps of automatically determining whether a connection may be made are performed according to the given sequence of servers listed in the server guide.

9. The method of claim 1, wherein the server guide identifies each server in the list through a server address and server type.

10. A computer implemented method for managing a retrieval of multimedia content from a content server over a computerized network, the network having a plurality of servers connectable to one or more clients, the method comprising:
retrieving at a first client a server guide identifying a list of servers capable of delivering a selected item of multimedia content from the content server, the list including a multicast router and a multicast-in unicast-out proxy router;
the first client automatically determining whether a connection may be made to the multicast router identified in the server guide to achieve delivery of the selected content item;
if the connection may be made to the multicast router, the first client establishing a connection with the multicast router to retrieve the selected content item therefrom;
if the connection is unable to be made to the multicast router, the first client automatically determining whether a connection may be made to the multicast-in unicast-out proxy router identified in the server guide to achieve delivery of the selected content item; and
if the connection may be made to the multicast-in unicast-out proxy router, the first client establishing a connection with the multicast-in unicast-out proxy router to retrieve the selected content item therefrom.

11. The method of claim 10, wherein the list of servers further includes a multicast-in unicast-TCP-out proxy, and comprising, if the connection is unable to be made to the multicast-in unicast-out proxy router, the first client automatically determining whether a connection may be made to the multicast-in unicast-TCP-out proxy identified in the server guide to achieve delivery of the selected content item.

12. A computer readable medium storing program code for, when executed, causing a computer to perform a method for managing a retrieval of multimedia content over a computerized network, the network having a plurality of servers connectable to one or more clients, the method comprising:
(a) retrieving at a first client a server guide identifying a list of servers capable of delivering a selected item of multimedia content;
(b) the first client automatically determining whether a connection may be made to a first server identified in the server guide to achieve delivery of the selected content item;
(c) if the connection may be made, the first client establishing a connection with the first server to retrieve the selected content item therefrom;
(d) if the connection is unable to be made, the first client automatically determining whether a connection may be made to a second server identified in the server guide to achieve delivery of the selected content item; and
the first client repeating steps (c) and (d) for the second server and any additional server identified in the server guide until a connection may be made to a server by which the selected content item may be delivered.

13. A system for establishing a connection over a network to retrieve multimedia content, the system comprising:
a memory device storing a server guide identifying a list of servers capable of delivering a selected item of multimedia content, the list including servers differing in transmission techniques; and
a connection manager for automatically attempting to establish a connection to the servers contained in the list one at a time and, upon determining that a connection can not be established for a given server, attempting to establish a connection to another server in the list until a connection is established or connections can not be established to all servers.

14. The system of claim 13, wherein the list of servers includes at least one server configured to multicast the content item and at least one server configured to unicast the content item.

15. The system of claim 14, wherein the list of servers includes two or more of the following: a multicast router, a multicast-in unicast-out proxy router, and a multicast-in unicast-TCP-out proxy.
